(19) United States
(12) Patent Application Publication
(10) Pub. No.: US 2009/0034771 A1
(43) Pub. Date: Feb. 5, 2009

(54) LOUDSPEAKER SYSTEM AND MOUNTING ARRANGEMENT FOR AN ELECTRIC AND/OR ELECTRONIC DEVICE

(75) Inventors: ACHIM GLEISSNER, Diekholzen (DE); David P. Theis, Cobb, CA (US); Wlodek Sielski, Kent (GB); Suzanne Fiona Sielski Waters, Kent (GB)

Correspondence Address: Gerald H. Kiel, Esq.;REED SMITH LLP, 599 Lexington Avenue, New York, NY, 10022-7650, US

(73) Assignee: K+H Vertriebs- und Entwicklungsgesellschaft mbH

(21) Appl. No.: 12/132,088

(22) Filed: Jun. 3, 2008

(30) Foreign Application Priority Data
Aug. 3, 2007 (DE) 10 2007 036 761.0

(51) Int. Cl. H04R 1/02

(52) U.S. Cl. 381/332; 381/386; 381/388

(57) ABSTRACT

There is provided a loudspeaker system having a loudspeaker unit with at least one electroacoustic transducer and a mounting holder. The mounting holder has a first end and a second end, wherein the first end can be fixed to a fixed mounting location. The second end of the mounting holder is in the form of a mounting plate in substantially perpendicular relationship to the mounting holder. The loudspeaker unit has a fixing unit. The mounting plate and the fixing unit are respectively of such a design configuration that the fixing unit can be pushed onto the mounting plate for mechanical mounting of the loudspeaker unit. The first electrical contacting means on the mounting plate and the second electrical contacting means on the fixing unit are arranged in such a way that the first and second electrical contacting means ensure an electrical contact when the fixing unit of the loudspeaker unit is pushed onto the mounting plate of the mounting holder.

### CROSS-REFERENCE TO RELATED APPLICATION

This application claims priority of German Application No. 10 2007 036 761.0., Aug. 3, 2007, the complete disclosure of which is hereby incorporated by reference.

### FIELD OF THE INVENTION

The present invention concerns a loudspeaker unit and a mounting arrangement for an electric and/or electronic device.

### DESCRIPTION OF THE RELATED ART

In the electroacoustic installation field loudspeakers must be both mechanically fixed and also electrically reliably contacted. For that purpose it is possible for example to use what are referred to as built-in loudspeakers, wherein the reproduction transducer or the loudspeaker is provided in a casing or in a box. The box with the reproduction transducer is electrically connected to an audio system by a cable connection so that the audio signals to be reproduced can be transmitted from the audio system to the box by means of the cable connection and can be reproduced by means of the box. That box with the reproduction transducer has to be mounted mechanically to a ceiling or a wall. Typically electrical installation and mechanical mounting are implemented independently of each other. That can be effected for example in such a way that the loudspeaker is fixed mechanically to a wall or a ceiling and then an electrical cable connection is made. Accordingly the procedure for mounting loudspeaker units or loudspeaker boxes has to be effected in a plurality of working steps (electrical and mechanical). Such a mounting procedure can appear to be difficult as the mounting fitter requires both hands for secure mounting. Sometimes therefore more than one fitter or colleague may be required for the installation or mounting procedure. In addition the cable connection or the connecting cable is often visible, which can sometimes be perceived as being visually detrimental.

A system test for the entire connecting cable is only possible when the boxes or loudspeaker units are mounted in position. The situation can thus involve incorrect polarities or interchange of the electrical connections. Particularly if reproduction transducers or loudspeaker units of that kind are used in the open air, electrical contacting may be susceptible to corrosion.

WO 2007/021338 A2 discloses an arrangement for mounting a loudspeaker. The mounting arrangement has a mounting plate which is designed to be substantially vertical relative to the mounting device. A fixing device secured to the loudspeaker unit can then be pushed onto the mounting plate.

U.S. Pat. No. 6,685,150 B2 discloses a mounting device for a loudspeaker, wherein a fixing unit secured to the loudspeaker can be hookingly engaged into the mounting arrangement, in which case an electrical contact can be made in that situation. In that respect however the electrical contact is in the open and is accordingly not protected.

### OBJECT AND SUMMARY OF THE INVENTION

Therefore a primary object of the present invention is to provide a loudspeaker unit and a mounting arrangement for an electric and/or electronic device, which permits simple and secure mounting of a loudspeaker unit.

That object is attained by a loudspeaker system in accordance with the invention comprising a loudspeaker unit having at least one electroacoustic transducer and a mounting holder. The mounting holder has a first end and a second end. The first end of the mounting holder is adapted to being fixed to a fixed mounting location. The second end of the mounting holder is in the form of a mounting plate. The loudspeaker unit has a fixing unit. The mounting plate and the fixing unit are respectively of a design configuration such that the fixing unit can be pushed onto the mounting plate for mechanical mounting of the loudspeaker unit. A first electrical contacting means is arranged on the fixing unit in such a way that the first and second electrical contacting means ensure an electrical contact when the fixing unit of the loudspeaker unit is pushed onto the mounting plate of the mounting holder. A mounting arrangement for an electric and/or electronic device such as a loudspeaker unit is also in accordance with the invention comprising a mounting holder having a first end for fixing to a fixed mounting location and a second end for receiving an electric and/or electronic device. The second end is in the form of a mounting plate for receiving a fixing unit of the electric and/or electronic device. The mounting plate and the fixing unit are respectively of a design configuration that the fixing unit can be pushed onto the mounting plate for mechanical mounting of the loudspeaker unit. A first electrical contacting means is arranged on the mounting plate and a second electrical contacting means is arranged on the fixing unit in such a way that the first and second electrical contacting means ensure an electrical contact when the fixing unit is pushed onto the mounting plate of the mounting holder.

Thus there is provided a loudspeaker system having a loudspeaker unit with at least one electroacoustic transducer and a mounting holder. The mounting holder has a first end and a second end, wherein the first end can be fixed to a fixed mounting location. The second end of the mounting holder is in the form of a mounting plate. The loudspeaker unit has a fixing unit. The mounting plate and the fixing unit are each of such a design configuration that the fixing unit can be pushed on the mounting plate for mechanically mounting the loudspeaker unit. A first electrical contacting means on the mounting plate and a second electrical contacting means on the fixing unit are in that respect arranged in such a way that the first and second electrical contacting means ensure an electrical contact when the fixing unit of the loudspeaker unit is pushed onto the mounting plate of the mounting holder.

The present invention also concerns a mounting arrangement for electric and/or electronic devices, in particular a loudspeaker unit. In that case the mounting unit has a mounting holder having a first end for fixing to a fixed mounting location and a second end for receiving the electric and/or electronic devices. The second end is in the form of a mounting plate for receiving a fixing unit of the electric and/or electronic device. A first electrical contacting means at the mounting plate can co-operate with a second electrical contacting means at the fixing unit in such a way that the first and second electrical contacting means ensure an electrical contact when the fixing unit is pushed onto the mounting plate of the mounting holder.

The invention is based on the idea of providing a holder or mounting holder for a loudspeaker for mounting to a fixed mounting location, typically or a wall or a ceiling, such as for example a wall holder or a ceiling holder, which optionally has a first electrical contact. A loudspeaker unit having an optional second electrical contact can be fitted or pushed onto the holder in such a way that mechanical and/or electrical connection is made. At its first end the holder is of a trapezoidal shape or a half-round shape. The holder is mounted with its second end on the wall. Thus the loudspeaker unit with the fixing unit is pushed onto the first end of the holder so that mechanical fixing occurs. In that respect the fixing unit is designed in such a way that it covers over the electrical contacts when the loudspeaker unit is pushed onto the holder. In addition thereto the electrical contacts can be provided both in the holder and also in the fixing unit of the loudspeaker in such a way that an electrical connection is made between the electrical contacts when the loudspeaker is pushed onto the wall holder.

Advantages and embodiments by way of example of the present invention are described in greater detail hereinafter with reference to the drawings.

### BRIEF DESCRIPTION OF THE DRAWINGS

In the drawings:

FIG. 1 shows a diagrammatic view of the loudspeaker unit in accordance with a first embodiment;

FIG. 2 shows a diagrammatic view of mounting plate in accordance with a first embodiment;

FIG. 3 shows a diagrammatic view of a fixing unit in accordance with a first embodiment; and

FIG. 4 shows a diagrammatic view of the loudspeaker unit in accordance with a second embodiment.

### DESCRIPTION OF THE PREFERRED EMBODIMENTS

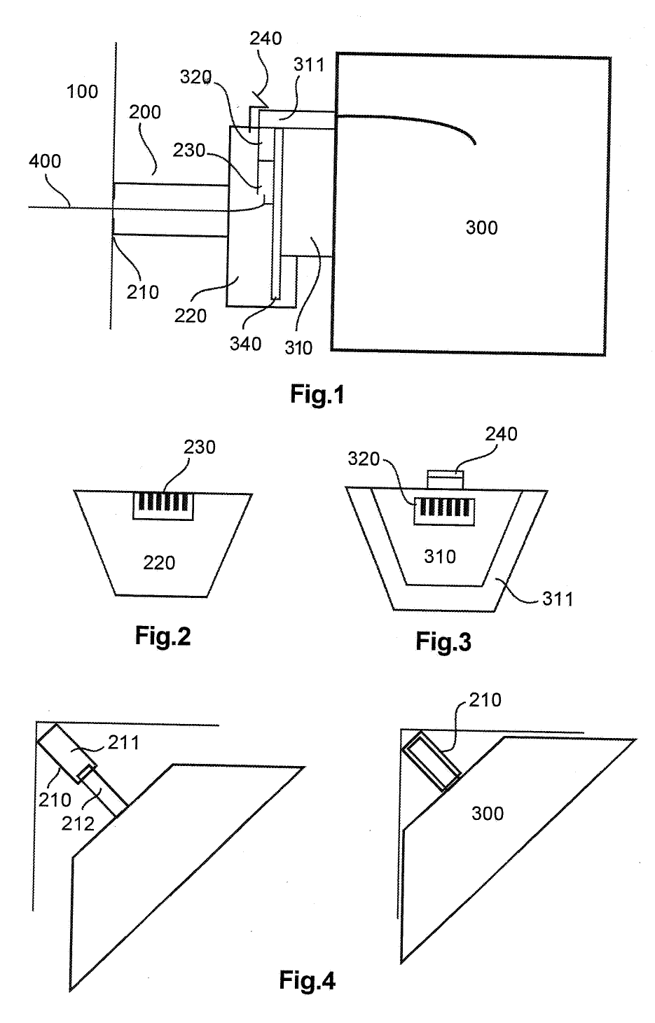

FIG. 1 shows a diagrammatic view of a loudspeaker unit in accordance with a first embodiment. In FIG. 1 a mounting holder or wall holder 200 is fixed to a wall 100. A loudspeaker unit 300 is fixed to the wall holder 200. The wall holder 200 can also be in the form of a ceiling holder and can be of a pivotable design. The wall holder 200 has an end 210 which is fixed to the wall 100. The second end 220 of the wall holder 200 serves to receive the loudspeaker unit 300 (in particular releasably). For that purpose the end 220 of the wall holder 200 is for example in the form of a mounting plate which is arranged substantially perpendicularly with respect to the wall holder and which is preferably fixedly secured to the wall holder. A first electrical contacting means 230 can optionally be provided on the mounting plate 220.

The loudspeaker unit 300 has a loudspeaker fixing unit 310 optionally with a further electrical contacting means 320. The fixing unit 310 is in that respect designed in such a way that it can be pushed over the mounting plate 220 for fixing the loudspeaker unit 300 to the wall holder 200. In addition the first and second electrical contacting means 230 and 320 are each arranged on the wall holder 200 and the fixing unit 310 respectively in such a way that an electrical contact is made between the first and second electrical contacting means when the fixing unit 320 is pushed onto the mounting plate 220.

The fixing unit 310 preferably has an opening 311 in the edge region, that opening being of such a configuration that it can receive the mounting plate 220 and surround or cover it. When the fixing unit 310 is pushed onto the mounting plate 220 the fixing unit at least partially covers over the mounting plate. That is particularly advantageous insofar as that ensures protection for the mounting plate and in particular the electrical contacting configuration between the mounting plate 220 and the fixing unit 310.

FIG. 2 shows a diagrammatic view of the mounting plate in accordance with the first embodiment. The mounting plate 220 has a first electrical contacting means 230. In this arrangement the mounting plate is of a trapezoidal configuration or a semicircular configuration.

FIG. 3 shows a diagrammatic view of a fixing unit for the loudspeaker unit in accordance with a first embodiment. The fixing unit 310 has a second electrical contacting means 320 which is adapted to co-operate with the first electrical contacting means 230 in order to ensure an electrical contact. In this case the fixing unit 310 is of such a configuration that it can be pushed over the mounting plate 220 to provide for secure mechanical fixing of the loudspeaker unit to the wall holder. The fixing unit 310 has an opening 311 in its edge region. In the case that opening is of such a configuration that it at least partially covers over the mounting plate 220 when the fixing unit 310 is pushed onto the mounting plate 220. The opening 310 can also be in the form of an overhang. The fixing unit can thus embrace the mounting plate 220 when the mounting plate is pushed into the fixing unit 310. The opening 311 represents a complementary opening in relation to the mounting plate 220. The fixing unit 310 can be releasably fixed to the mounting plate 220 and the fixing unit is fixed in the mounted condition.

The fact that the mounting plate is designed for example in the form of a trapezoid or a semicircle can permit a centering action when mounting the fixing unit 310.

Preferably an electrical cable 400 is laid in the wall holder and electrically coupled to the first electrical contacting unit 320. In that way the required connecting cable can be laid within the wall holder so as to be invisible from the exterior. The mounting plate 220 is preferably made from steel or another metal.

The mechanical connection between the wall holder and the loudspeaker unit is thus made by way of a preferably trapezoidal mounting plate which is fixed to the wall holder and a correspondingly recessed counterpart portion as the fixing unit on the loudspeaker unit. In that case the loudspeaker unit is pushed onto the mounting plate perpendicularly with respect to the wall holder. In addition to that mechanical connection an electrical contacting can also be provided when a first electrical contacting unit is provided in the mounting plate and a second electrical contacting unit is provided in the fixing unit. In that way a mechanical connection can be made between the wall holder and the loudspeaker unit, without involving a tool. The configuration of the trapezoidal or half-round mounting plate (perpendicularly to the wall holder) and a correspondingly recessed counterpart portion in the fixing unit of the loudspeaker unit means that the loudspeaker box can be mounted with just one hand in the direction of the force of gravity. The geometry of the mounting plate and the fixing unit excludes the possibility of the loudspeaker unit being allowed to slip downwardly.

Optionally a resilient latching projection 240 can be provided on the mounting plate 220 or the fixing unit 31 0 so that upward slipping movement can be correspondingly prevented. Optionally a securing screw can be provided on or in the latching projection. It is thus also possible to provide corresponding anti-theft protection. Optionally sealing elements can be provided on the mounting plate or on the fixing unit 310 respectively to prevent the ingress of moisture and thus to ensure weather-resistance.

FIG. 4 shows a loudspeaker unit in accordance with a second embodiment. The loudspeaker unit in accordance with the second embodiment is designed to be mounted in a corner. For that purpose the wall holder has a telescopic unit 211, 212. The one end of the wall holder is fixed to the wall and the other end of the wall holder has a mounting plate in accordance with the first embodiment. The loudspeaker unit in accordance with the second embodiment has a fixing unit in accordance with the first embodiment.

The wall holder can be fixed directly to the wall, by way of a cantilever arm with an optional ball head or on the wall by way of a telescopic arrangement.

In accordance with a third embodiment there is provided a cover cap which can be fitted on the mounting plate 220 for protecting the mounting plate and in particular the electrical contacting means on or in the mounting plate. That cover cap can be provided on the mounting plate for example for affording protection from fouling during a building phase. The cover cap has a complementary opening for receiving the mounting plate. The cover cap at least partially embraces the mounting plate when the cover cap is pushed onto the mounting plate. Additionally or alternatively thereto the cover cap can have a third electrical contacting means and an electronic circuit which is adapted to simulate the loudspeaker unit and indicate the polarity of the connections.

The above-described mounting arrangement can alternatively also be used in relation to kitchen appliances, as wall holders for TV appliances, for monitoring cameras and for DMX-controllable lighting units.

Although a wall or ceiling holder has been described hereinbefore the invention can also be applied to a mounting holder which is fixed to a fixed mounting location, typically a wall or a ceiling. Thus the holder can also be fixed to a support framework or scaffolding, a stage support structure, a mast or the like.

While the foregoing description and drawings represent the present invention, it will be obvious to those skilled in the art that various changes may be made therein without departing from the true spirit and scope of the present invention.

What is claimed is:

1. A loudspeaker system comprising:
a loudspeaker unit having at least one electroacoustic transducer and a mounting holder;
said mounting holder having a first end and a second end;
said first end of the mounting holder adapted to being fixed to a fixed mounting location;
said second end of the mounting holder being in the form of a mounting plate;
said loudspeaker unit having a fixing unit;
said mounting plate and said fixing unit being respectively of a design configuration such that the fixing unit can be pushed onto the mounting plate for mechanical mounting of the loudspeaker unit; and
a first electrical contacting means being arranged on the mounting plate and a second electrical contacting means being arranged on the fixing unit in such a way that the first and second electrical contacting means ensure an electrical contact when the fixing unit of the loudspeaker unit is pushed onto the mounting plate of the mounting holder.

2. The loudspeaker system as set forth in claim 1, wherein the fixing unit has an opening which is complementary to the mounting plate and which is so designed that when the fixing unit is pushed onto the mounting plate the fixing unit at least partially embraces the mounting plate.

3. The loudspeaker system as set forth in claim 1, wherein a latching unit is provided on the mounting plate or the fixing unit in such a way that it prevents the fixing unit from being removed from the mounting plate.

4. The loudspeaker system as set forth in claim 1, wherein the mounting holder is in the form of a telescopic means.

5. The loudspeaker system as set forth in claim 1, wherein the mounting holder is adapted to be pivotable.

6. A mounting arrangement for an electric and/or electronic device, such as a loudspeaker unit, comprising:
a mounting holder having a first end for fixing to a fixed mounting location and a second end for receiving an electric and/or electronic device;
said second end being in the form of a mounting plate for receiving a fixing unit of the electric and/or electronic device;
said mounting plate and said fixing unit being respectively of such a design configuration that the fixing unit can be pushed onto the mounting plate for mechanical mounting of the loudspeaker unit; and
a first electrical contacting means being arranged on the mounting plate and a second electrical contacting means being arranged on the fixing unit in such a way that the first and second electrical contacting means ensure an electrical contact when the fixing unit is pushed onto the mounting plate of the mounting holder.

7. The mounting arrangement as set forth in claim 6, wherein the mounting plate is of a trapezoidal or half-round configuration.

8. A loudspeaker unit comprising:
a fixing unit for fixing to a mounting arrangement as set forth in claim 6, wherein the fixing unit is so designed that it can be pushed onto the mounting plate of the mounting holder as set forth in claim 6.

9. The cover cap unit for covering the mounting plate of a mounting arrangement as set forth in claim 6.

10. The cover cap unit for covering an end of a mounting arrangement as set forth in claim 6, wherein the cover cap is so designed that it is pushed onto the mounting plate and covers the electrical contacting means of the mounting plate.
